(19) United States
(12) Patent Application Publication
(10) Pub. No.: US 2017/0100831 A1
(43) Pub. Date: Apr. 13, 2017

(54) BELT COOLING SYSTEM

(71) Applicant: Hilti Aktiengesellschaft, Schaan (LI)

(72) Inventors: Wolfgang Schreiber, Jengen (DE); Torsten Luettich, Essen (DE)

(21) Appl. No.: 15/128,844

(22) PCT Filed: Mar. 24, 2015
(86) PCT No.: PCT/EP2015/056192

§ 371 Date: Sep. 23, 2016

(30) Foreign Application Priority Data
Mar. 25, 2014 (EP) 14161412.3

(51) Int. Cl. B25F 5/00; B28D 1/04

(52) U.S. Cl. CPC B25F 5/008; B28D 1/041

(57) ABSTRACT

A power tool having a housing, a motor, especially an electric motor, a drive shaft that can be driven by the motor, a belt drive for transmitting the driving force of the motor to a tool, and a first fan that serves to generate a first air path in the housing as well as to cool at least the motor. The first fan and the belt drive can be driven by the drive shaft. The power tool has a second fan that serves to generate a second air path in the housing as well as to cool at least the belt drive.

The invention relates to a power tool that has a housing, a motor, especially an electric motor, a drive shaft that can be driven by the motor, a belt drive for transmitting the driving force of the motor to a tool, and a first fan that serves to generate a first air path in the housing as well as to cool at least the motor. The first fan and the belt drive can be driven by means of the drive shaft.

### BACKGROUND

With some power tools such as, for instance, core drills, the power take-off of the motor is effectuated by a belt drive. Here, a belt (timing belt) is connected to the drive shaft via a gear wheel or belt pulley and the drive shaft, in turn, is driven by the motor. Elevated temperatures can arise at the contact site between the belt pulley and the belt. Damage can occur to the belt drive due to these elevated temperatures and this can also result in a complete failure of the belt drive. This is why there is normally some kind of cooling measure to appropriately cool the belt drive. Prior-art cooling measures for power tools with belt drives usually entail active cooling with an air path. This air path is generated by means of a fan (blower). Here, the fan is often positioned in the power tool in such a way that, in addition to the belt drive, the motor as well as the electronics are appropriately cooled. The air flow (air path) generated by the fan to cool the motor, the electronics and the belt drive is often first directed at the motor so as to achieve a maximum cooling of the motor while the air flow that is still relatively cool. Subsequently, the air flow is directed at the electronics for cooling purposes. In this process, the air flow is additionally warmed up. Lastly, the air flow reaches the belt drive in order to cool it. Since the air flow generated by the fan is first directed at the motor and at the electronics in order to cool them, and only directed at the belt drive after that, the temperature of the air flow will already have risen markedly as a result its having cooled the motor and the electronics, so that the belt drive can no longer be optimally cooled. If the belt drive is not optimally cooled, the temperature of the belt drive, especially at the contact site between the belt pulley and the belt, can rise to such an extent that there is a risk of damage to and/or complete failure of the belt drive and of the entire power tool.

### SUMMARY OF THE INVENTION

It is an object of the present invention to provide a power tool entailing an improved cooling of the belt drive in order to reduce the susceptibility to wear and failure on the part of the belt drive or of the power tool.

The present invention provides a power tool that has a housing, a motor, especially an electric motor, a drive shaft that can be driven by the motor, a belt drive for transmitting the driving force of the motor to a tool, and a first fan that serves to generate a first air path in the housing as well as to cool at least the motor, whereby the first fan and the belt drive can be driven by means of the drive shaft.

According to the present invention, the power tool has a second fan that serves to generate a second air path in the housing as well as to cool at least the belt drive. In this manner, an additional air path or air flow is made available exclusively for cooling the belt drive. As a result, the cooling of the belt drive is greatly improved and a heat-induced failure of the belt drive is appropriately countered.

According to another embodiment of the present invention, it can be provided that the second fan can be driven by means of the drive shaft. In this manner, it is possible to dispense with an additional drive for the second fan, and the driving force of the drive shaft can be utilized very efficiently to drive the second fan. Moreover, the installation space of the housing can be used efficiently owing to the serial arrangement of the two fans relative to each other.

In order to prevent dirt particles from being drawn into the interior of the housing of the power tool along with the air that is drawn in from the surroundings to cool the fans, it is advantageous for the first air path to have an intake opening on the outside of the housing and for the second air path to have an intake opening on the outside of the housing, and whereby the first and second intake openings are positioned on a side of the housing facing away from the tool. There are fewer dirt particles in the ambient air on the side of the housing facing away from the tool, since, on this side of the housing, fewer dirt particles are created during the operation of the tool that then get into the ambient air.

According to another advantageous embodiment of the present invention, it can be provided that the second fan is positioned with respect to the belt drive in such a way that the belt drive that is to be cooled is at least partially situated in an excess-pressure area generated by the second fan. Owing to the excess pressure, the ambient air that is near the tool and that has been contaminated by dirt particles is prevented from getting into the belt drive.

In order to avoid that the first air path, which serves at least to cool the motor, might influence or even warm up the second air path, according to another advantageous embodiment, it can be provided that the first air path and the second air path are positioned at least partially separately from each other in the housing.

According to another advantageous embodiment of the present invention, it can be possible for the second fan to be made at least partially of metal. In this manner, a better thermal connection of the fan to the drive shaft as well as to the belt drive can be ensured, as a result of which a faster heat dissipation from the belt drive to the second air path is possible.

### BRIEF DESCRIPTION OF THE DRAWINGS

Additional advantages ensue from the description of the drawings below. The drawings show an embodiment of the present invention. The drawings, the description and the claims contain numerous features in combination. In a practical manner, the person skilled in the art will also consider the features individually and will combine them into additional practical configurations.

The following is shown:

FIG. 1 a perspective view of a part of the power tool according to the invention;

FIG. 2 a bottom view of the housing of the power tool;

FIG. 3 an internal view along the sectional line A-A in FIG. 2 of the power tool with a belt drive;

FIG. 4 an internal view along the sectional line A-A in FIG. 2 of the power tool without a belt drive;

FIG. 5 an internal view of the power tool without a belt drive and with a partially opened housing; and

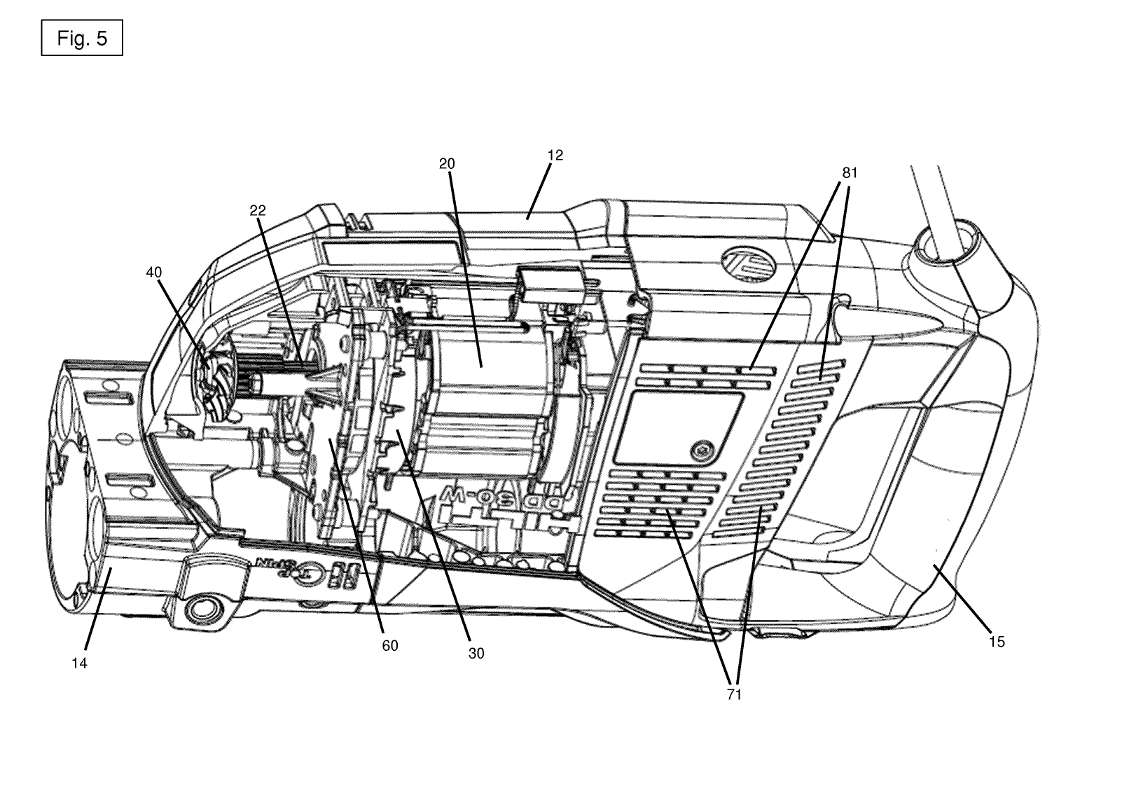

FIG. 6 a bottom view of the power tool without a belt drive and with a partially opened housing.

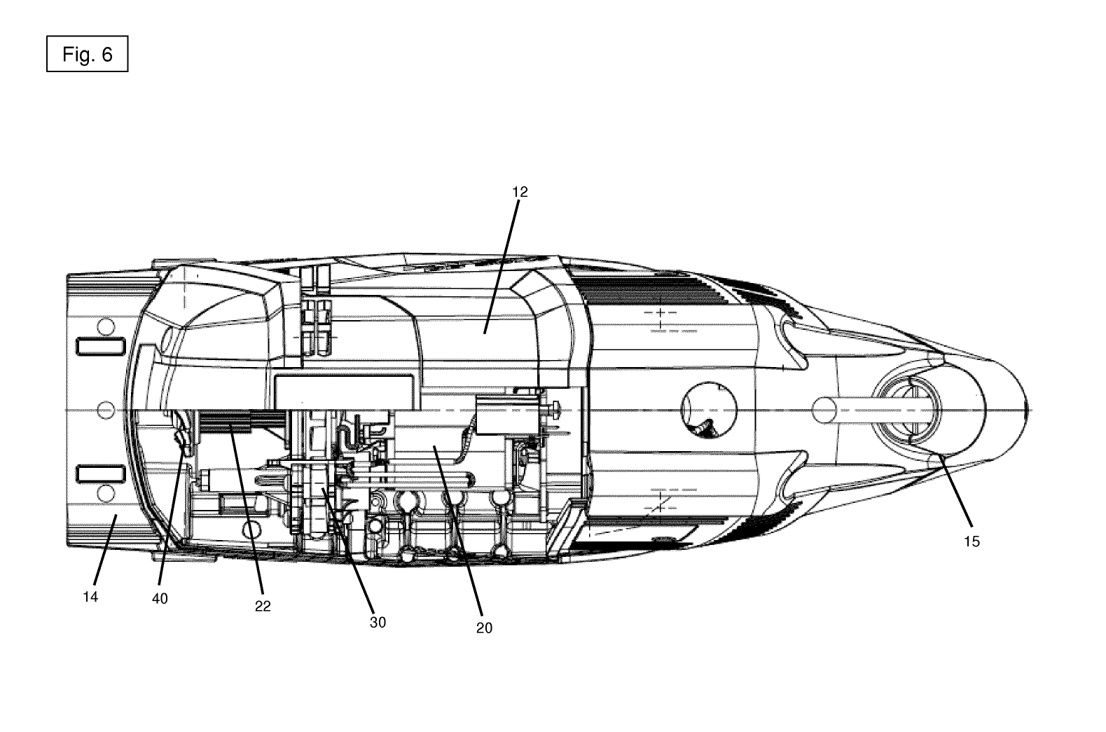

### DETAILED DESCRIPTION

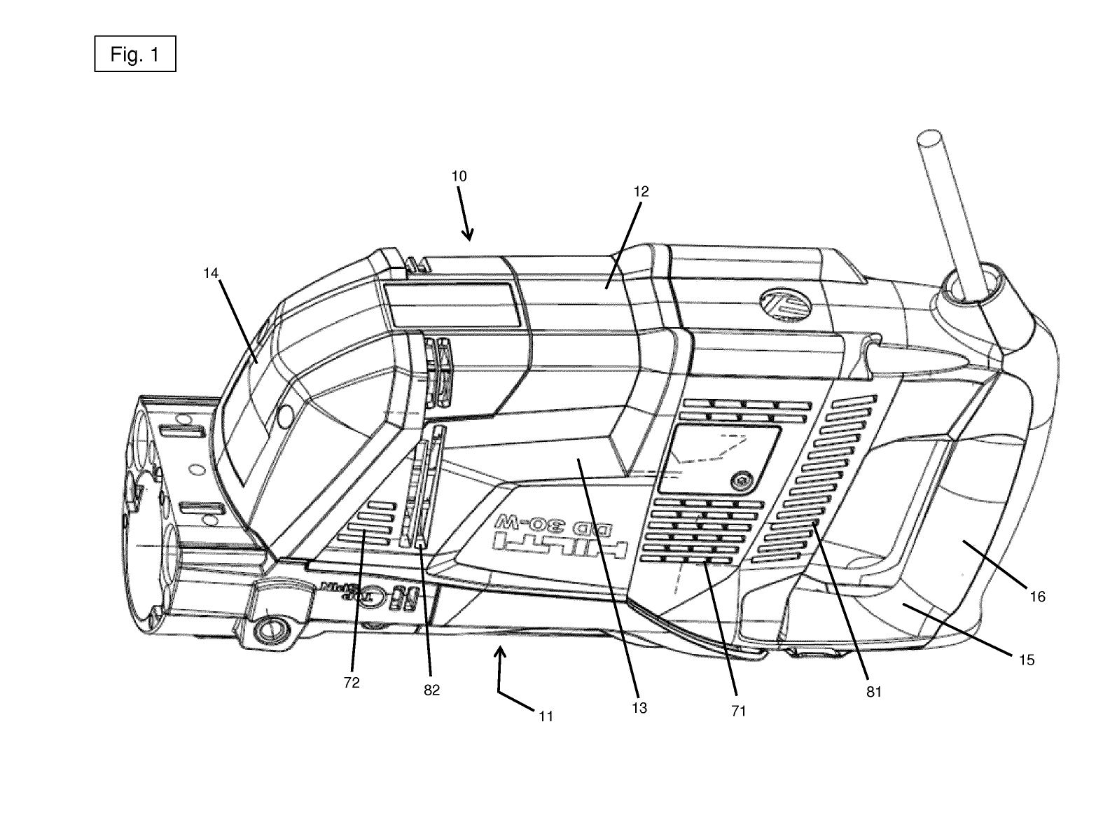

FIG. 1 shows a power tool 1 according to a first embodiment. The power tool 1 is a core drill with a belt drive 50.

The power tool 1 configured as a core drill comprises a housing 10, an electric motor 20, a drive shaft 22, a first fan 30, a second fan 40, and a belt drive 50.

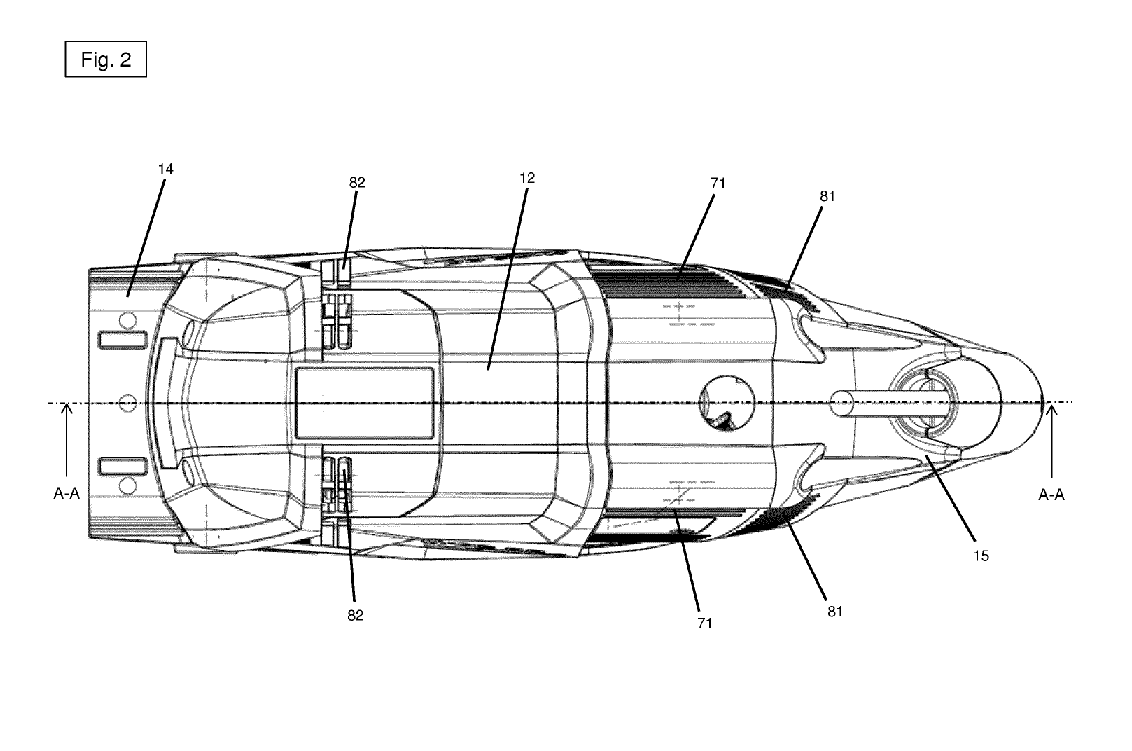

The housing 10 comprises a top 11, a bottom 12, a right-hand side 13, a left-hand side (not shown here), a front end 14 and a rear end 15. FIG. 1 shows the bottom 12, the front end 14 and the right-hand side 13 of the housing 10. FIG. 2 especially shows the bottom 12 of the housing 10. A tool in the form of a core bit (not shown here) can be positioned on the front end 14. There is a handle 16 on the rear end 15 that allows a user (not shown here) to hold or guide the core drill 1. The right-hand side 13 shown in FIG. 1 is essentially identical to the left-hand side (not shown here).

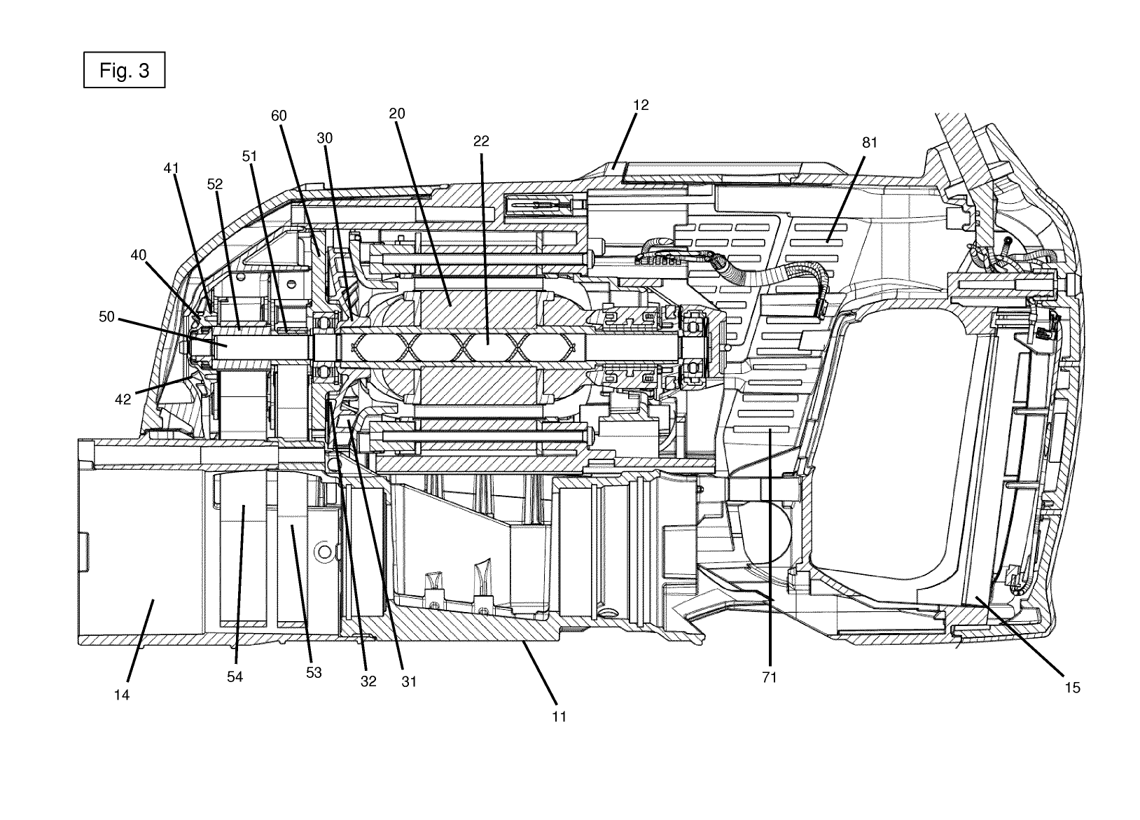

As is shown in FIG. 3, the electric motor 20 is positioned in the housing 10 and transmits a torque generated in the electric motor 20 to the drive shaft 22, which is rotatably joined to the electric motor 20.

The first fan 30 as well as the second fan 40 are configured in the form of an axial blower, whereby the first fan 30 and the second fan 40 are of different sizes and especially of different diameters. The first fan 30 has a first side 31 and a second side 32. Moreover, the second fan 40 also has a first side 41 and a second side 42. According to the first embodiment, the first fan 30 is larger than the second fan 40. The first fan 30 and the second fan 40 are non-rotatably positioned on the drive shaft 22, so that the drive shaft 22 can cause them to rotate. When the fans 30, 40 are rotating, they generate a negative air pressure on the respective first sides 31, 41 and an excess air pressure on the respective second sides 32, 42. Due to the generated negative air pressure, air can be drawn in by the fans 30, 40. Accordingly, air can be pushed away from the fans 30, 40 due to the generated excess air pressure. As will be described in detail below, the fans 30, 40 blow air through the air paths.

The belt drive 50 comprises a first belt pulley 51, a second belt pulley 52, a third belt pulley (not shown here), a fourth belt pulley (not shown here), a first belt 53 and a second belt 54. The first belt pulley 51 serves to transmit the torque from the drive shaft 22 to the first belt 53. The second belt pulley 52 transmits the torque from the drive shaft 22 to the second belt 54. The first belt 53 transmits the torque to the third belt pulley, and the second belt 54 transmits the torque to the fourth belt pulley. The third and fourth belt pulleys transmit the torque further to a tool (for example, a core bit), (not shown here), by means of which a material can be worked.

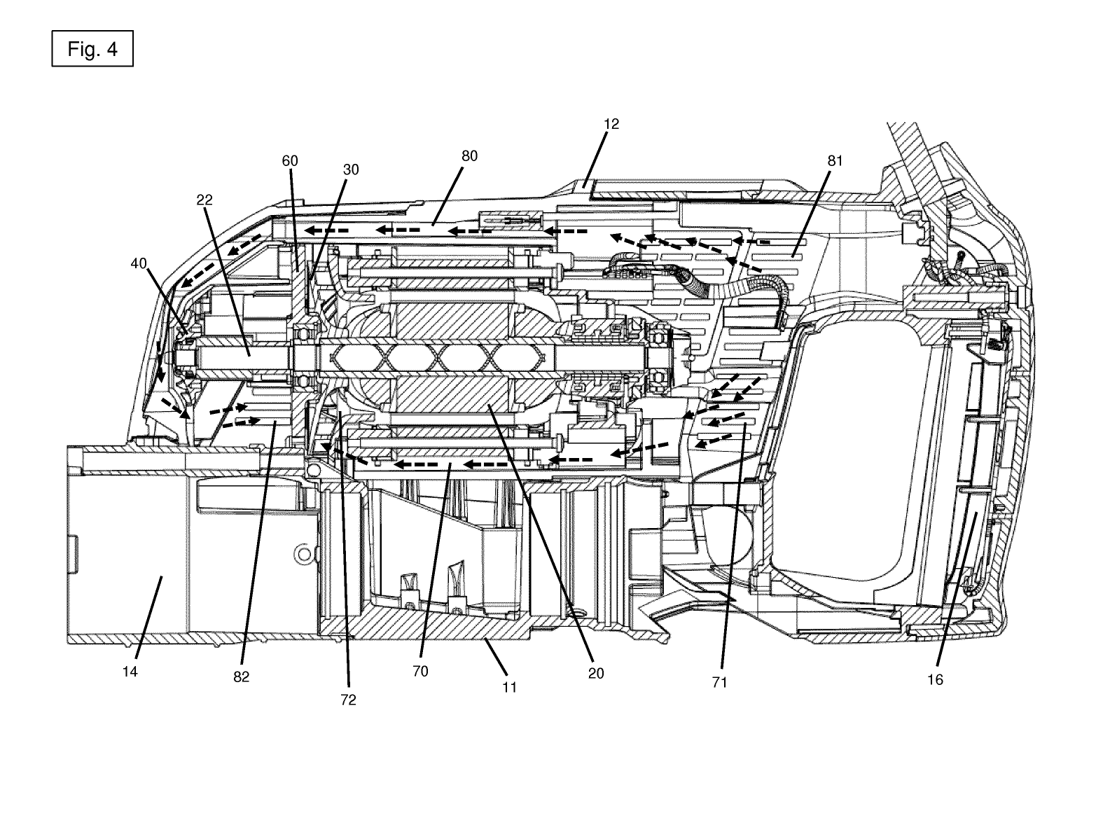

A shown in FIGS. 3 and 4, the first fan 30, the first belt pulley 51, the second belt pulley 52 and the second fan 40 are positioned one after the other on the drive shaft 22 in such a way that the torque of the drive shaft 22 is transmitted to them. The first fan 30 and the second fan 40 are made to rotate synchronously by means of the drive shaft 22. A bearing plate 60 is positioned between the first fan 30 and the second fan 40. The bearing plate 60 is situated especially between the first fan 30 and the first belt pulley 51. The bearing plate 60 serves as a partition in order to create an air-tight separation between the space in front of the bearing plate 60 and the space behind the bearing plate 60.

The housing 10 comprises a first air path 70 or air channel as well as a second air path 80 or air channel (see FIG. 4). The first air path 70 has a first opening 71, a second opening 72 and an elongated channel 73. The first opening 71 and the second opening 72 are positioned on the outer surface of the housing 10 (see FIGS. 1 and 2). According to the first embodiment, the first opening 71 and the second opening 72 are not separated from each other and they share the same inlet into the housing 10 (see FIGS. 1 and 4). According to a second embodiment (not shown here), however, it can also be provided that the first opening 71 and the second opening 72 are separated from each other and do not share the same inlet into the housing 10. Here, the first opening 71 and the second opening 72 each have their own inlet into the housing 10.

Once the first fan 30 has been made to rotate by means of the drive shaft 22, air is drawn in from the surroundings and it enters the first air path 70 through the first opening 71, which serves as the inlet. Therefore, the first opening 71 can be referred to as an intake opening. Via the elongated channel 73, the air that has been drawn in by the fan 70 ultimately reaches the second opening 72. The second opening 72 serves as the outlet through which the air can then exit the housing 10. The first air path 70 is positioned in the housing 10 in such a way that the elongated channel 73 extends past the electric motor 20. In this manner, the air in the first air path 70 is conveyed past the electric motor 20. When the air is conveyed past the electric motor 20, heat from the electric motor 20 is transferred to the air due to thermal convection so that the electric motor 20 is cooled.

The second air path 80 likewise has a first opening 81, a second opening 82 and an elongated channel 83. The first opening 81 and the second opening 82 are also positioned on the outer surface of the housing 10. The second opening 82 is situated here on the side of the housing 10 facing away from the tool (not shown here). Once the second fan 80 has likewise been made to rotate by means of the drive shaft 22, air is drawn in from the surroundings and it enters the second air path 80 through the first opening 81, which serves as the inlet. Therefore, the first opening 81 can be referred to as an intake opening. For this purpose, in the flow direction of the air upstream from the second fan 80, there is a negative air pressure that draws in the air. The flow direction of the air is shown by the small arrows in FIG. 4. The second fan 80 is positioned in the vicinity of the second opening 82 so that the second fan 80 pushes the air out of the housing 10 through the second opening 82. For this purpose, the air downstream from the second fan 80 has an excess pressure that pushes the air away. Here, the second fan 80 is positioned relative to the belt drive 50 and especially relative to the first and second belt pulleys 51, 52 in such a way that the air is blown onto the belt drive 50 or onto the first and second belt pulleys 51, 52. In this way, first of all, the belt drive 50 is cooled and secondly, excess pressure is generated so that the second opening 82 only discharges air, and consequently, no air can enter the housing 10 through the second opening 82 and no air can reach the belt drive 50. The fact that the second opening 82 only discharges air and no air enters the housing 10 through the second opening 82 means that no ambient air that has been contaminated by dirt particles can penetrate (through the second opening) into the housing 10 and get into the belt drive 50.

1-6. (canceled)

7. A power tool comprising:
a housing;
a motor;
a drive shaft drivable by the motor;
a belt drive for transmitting the driving force of the motor to a tool; and
a first fan serving to generate a first air path in the housing as well as to cool at least the motor, the first fan and the belt drive drivable by the drive shaft; and
a second fan serving to generate a second air path in the housing as well as to cool at least the belt drive.

8. The power tool as recited in claim 7 wherein the second fan is drivable by the drive shaft.

9. The power tool as recited in claim 7 wherein the first air path has a first intake opening on an outside of the housing and the second air path has a second intake opening on the outside of the housing, and whereby the first and second intake openings are positioned on a side of the housing facing away from the tool.

10. The power tool as recited in claim 7 wherein the second fan is positioned with respect to the belt drive in such a way that at least part of the belt drive to be cooled is at least partially situated in an excess-pressure area generated by the second fan.

11. The power tool as recited in claim 7 wherein the first air path and the second air path are positioned at least partially separately from each other in the housing.

12. The power tool as recited in claim 7 wherein the second fan is made at least partially of metal.

13. The power tool as recited in claim 7 wherein the motor is an electric motor.
